(19) United States
(12) Patent Application Publication
(10) Pub. No.: US 2011/0182463 A1
(43) Pub. Date: Jul. 28, 2011

(54) ULTRA-THIN LOUDSPEAKER

(75) Inventor: PING-YU LEE, TAOYUAN COUNTY (TW)

(73) Assignee: FORTUNE GRAND TECHNOLOGY INC., Taoyuan County (TW)

(21) Appl. No.: 12/766,229

(22) Filed: Apr. 23, 2010

(30) Foreign Application Priority Data
Jan. 22, 2010 (TW) 099201303

(51) Int. Cl. H04R 1/00

(52) U.S. Cl. 381/412

(57) ABSTRACT

An ultra-thin loudspeaker including: a) an iron basin having a first receiving portion and a second receiving portion at the top surface thereof; b) a magnet unit positioned within the first receiving portion of the iron basin; c) a voice coil positioned around the magnet unit; and d) a vibrating diaphragm positioned within the second receiving portion. These are assembled to form a mini-speaker. Furthermore, the mini-speaker is enclosed by a top and a bottom metal cover. In this way, the mini-speaker of the invention resolves the heat-dissipating problem of the conventional thin loudspeaker. Moreover, the thickness of the entire loudspeaker may be minimized. In addition, an excellent concentration of the magnetic force is achieved and the production yield rate is increased.

### BACKGROUND OF THE INVENTION

1. Field of the Invention

The invention relates to an ultra-thin loudspeaker, and more particularly to a base employing an iron basin to fulfill both the magnetic conductive function and the heat-dissipating function.

2. Description of the Related Art

As 3C electronic devices such as mobile phones (or handsets), MP3 players, notebook computers (NB), liquid crystal displays (LCD), and personal digital assistants (PDA) have an enhanced operating performance, a compact design, and a multimedia function, the 3C electronic devices generally adopt an appropriate mini speaker for an audio output interface.

Speaker is an electro-acoustic device for converting electronic signals into audio signals, and producing a repulsion with a magnetic member to provide a piston-like action after a voice coil is electrically conducted, such that a vibrating membrane installed in front of the magnetic member is pushed accordingly to radiate sound waves in front of the vibrating membrane in all directions to the outside. However, the operation of the voice coil and the magnetic member may cause a high temperature easily, and the high temperature issue has become an inevitable drawback.

Since present existing consumer products become smaller and smaller, the electronic or plastic components installed inside the products are very close to the position of the speaker, therefore the piston action between the voice coil and the magnetic member will produce a high temperature after the voice coil of the speaker is electrically conducted. The high temperature not just affects the sound quality and performance of the speaker, but also affects the operation of adjacent components of the electronic device. Even worse, the continuously increasing temperature may burn the voice coil or damage the electronic device, or may even cause accidents.

The aforementioned speaker body has a poor heat dissipating effect, and the poor heat dissipation may burn the voice coil. The high temperature also affects the existing sound quality and performance. Therefore, manufacturers have provided solutions to overcome the heat dissipation issue of the voice coil. These solutions mainly include an improved convection of air, an improved structure of a speaker body, and an improved metal heat dissipating material.

As disclosed in R.O.C. Pat. No. 00305509, a dust-resisting cover of a speaker is made of a metal material instead, and the dust-resisting cover is installed to an opening of a voice coil directly, such that the heat produced by the voice coil can be discharged from the metal dust-resisting cover.

In an improved speaker assembly as disclosed in R.O.C. Pat. No. 00431741, external cold air is introduced into a gap between a voice coil and a magnetic member, and heat is discharged to the outside during the operation the speaker in order to avoid overheat of the voice coil.

As disclosed in R.O.C. Pat. No. 00453601, a circular heat sink is installed onto a voice coil directly and wrapped by a magnetic member for dissipating a high-temperature heat produced by the voice coil and the magnetic member.

As disclosed in R.O.C. Pat. No. M249394 (with a foreign counterpart P.R.C. Pat. No. ZL02288716.4), a heat dissipating plate is adhered onto a voice coil and a rear end of a magnetic member for discharging hot air produced in the operation of the speaker to avoid overheat of the voice coil.

In P.R.C. Pat. No. ZL200620014749.2, a circular heat sink similar to a washer (which is a magnetic conducting plate installed on a speaker body) is disclosed, wherein the heat sink is a serrated structure capable of expediting the dissipation of heat energy of the voice coil.

In P.R.C. Pat. No. ZL200720000787.7, a concave heat dissipating device is disclosed, and a magnetic yoke (U-shaped iron) under a magnet is installed in the concave heat dissipating device, and a thermal paste is applied to connect the magnetic yoke and the concave heat dissipating device securely, such that when the heat of the speaker body is conducted to the magnetic yoke, heat can be discharged quickly and directly to the outside through the external concave heat dissipating device.

In P.R.C. Pat. No. ZL99217826.6, a plurality of heat dissipating holes are formed around the periphery of a magnetic yoke (T-shaped iron), and a circular hole is formed on a magnetic pillar, and a plurality of fins are installed at the bottom of the magnetic yoke for improving the heat dissipating efficiency.

In P.R.C. Pat. No. ZL200520053787.4, the magnetic conduction of the original magnetic yoke (U-shaped iron) is separated from the function of fixing the magnetic member. By changing the material of the magnetic yoke from the traditional iron material to a lightweight material, we can reduce the weight of the speaker and achieve the effects of dissipating heat. Meanwhile, a heat sink is installed outside the magnetic yoke to improve the heat dissipating efficiency.

In P.R.C. Pat. No. ZL200420083784.0, a structure of an internal magnetic speaker body is disclosed to improve the heat dissipating efficiency of the speaker body and enhance the sound quality of base. In the improved internal magnetic speaker body structure, a serrated heat sink is installed outside a magnetic yoke (U-shaped iron) for conducting the heat of a voice coil to the heat sink through the magnetic yoke. Meanwhile, the heat sink includes an open groove formed in the circumferential direction and extended into an air chamber behind the vibrating membrane through an opening formed on a support frame of the speaker, such that the resonance frequency point F0 can be minimized without using an additional speaker enclosure to achieve the effect of enhancing the sound quality of base.

However, the methods or structures for solving the heat dissipation problem of the voice coil in accordance with the aforementioned prior arts still have a drawback of having a too-large volume that cannot fit in the limited space of the thin speaker.

In R.O.C. Pat. No. M352209 (with a foreign counterpart P.R.C. Pat. No. ZL2008201353250) issued to the inventor of the present invention, the structure of a thin mini speaker heat dissipating device is disclosed, wherein a metal plate is installed around a U-shaped magnetic yoke, such that the heat produced by the magnetic yoke can be conducted to the outside. Although this structure provides a function of dissipating heat to a certain extent, the metal plate must be installed in the space inside upper and lower casings, so that the heat dissipating area is limited. Furthermore, the overall thickness is still several millimeters, and such thickness still cannot meet the requirements of present electronic products such as mobile phones.

In view of the foregoing shortcomings of the prior arts, the inventor of the present invention further improves the heat dissipating efficiency and the thickness of the thin mini speakers in accordance with the present invention.

### SUMMARY OF THE INVENTION

An object of the invention is to provide an ultra-thin loudspeaker having a base that employs an iron basin to fulfill both the magnetic conductive function and the heat-dissipating function. In this way, the heat-dissipating area is increased, thereby resolving the heat-dissipating problem of the conventional thin loudspeaker.

Another object of the invention is to provide an ultra-thin loudspeaker whose thickness is reduced (by resolving the heat-dissipating problem of the conventional thin loudspeaker) to lower than 1.5 mm, even to approx. 1 mm, thereby facilitating the internal space design of the electronic products. Furthermore, the lightweight and thinness requirements are also fulfilled.

A further object of the invention is to provide an ultra-thin loudspeaker that ensures an excellent concentration of the magnetic force and increases the production yield rate. Meanwhile, the reliability of the product is enhanced and the tone quality is improved.

In order to achieve the above-mentioned objects, the invention includes:

a) an iron basin having a first receiving portion and a second receiving portion at the top surface thereof;

b) a magnet unit positioned within the first receiving portion of the iron basin;

c) a voice coil positioned around the magnet unit; and

d) a vibrating diaphragm positioned within the second receiving portion, whereby the iron basin, the magnet unit, the voice coil, and the vibrating diaphragm are assembled to form a speaker.

According to the invention, the magnet unit includes a single magnet. Alternatively, the magnet unit consists of an internal magnet and an external magnet.

According to the invention, the mini-speaker further includes a top metal cover and a bottom metal cover to enclose the speaker.

Based upon the above-mentioned structure, the iron basin is specially formed to resolve the thickness and the heat-dissipation problem. Meanwhile, the production yield rate and the concentration of the magnetic force may be increased, thereby ensuring a practical use.

### BRIEF DESCRIPTION OF THE DRAWINGS

The accomplishment of this and other objects of the invention will become apparent from the following descriptions and its accompanying figures of which:

FIG. 1 is an exploded perspective view of a first embodiment of the invention;

FIG. 2 is a perspective assembly view of the first embodiment of the invention;

FIG. 3 is a cross-sectional view of the first embodiment of the invention;

FIG. 4 is an exploded perspective view of the first embodiment of the invention with a top metal cover and a bottom metal cover;

FIG. 5 is a perspective assembly view of the first embodiment of the invention with a top metal cover and a bottom metal cover;

FIG. 6 is an exploded perspective view of a second embodiment of the invention;

FIG. 7 is a perspective assembly view of the second embodiment of the invention;

FIG. 8 is a cross-sectional view of the second embodiment of the invention;

FIG. 9 is an exploded perspective view of the second embodiment of the invention with a top metal cover and a bottom metal cover;

FIG. 10 is a perspective assembly view of the second embodiment of the invention with a top metal cover and a bottom metal cover.

### DETAILED DESCRIPTION OF THE PREFERRED EMBODIMENT

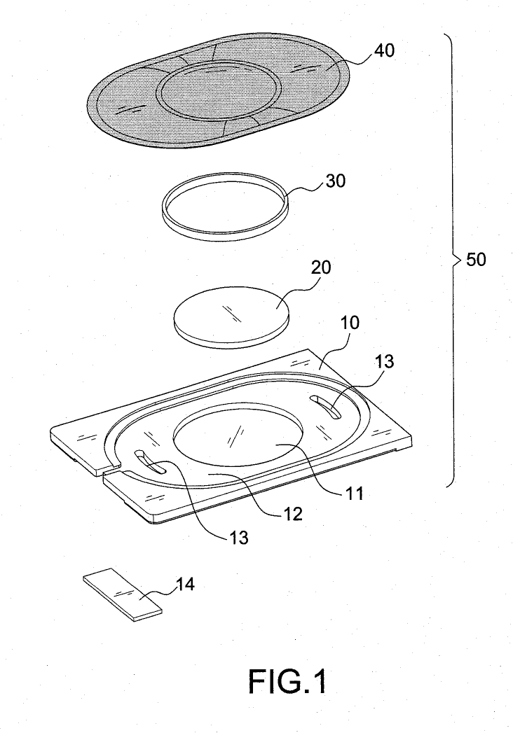

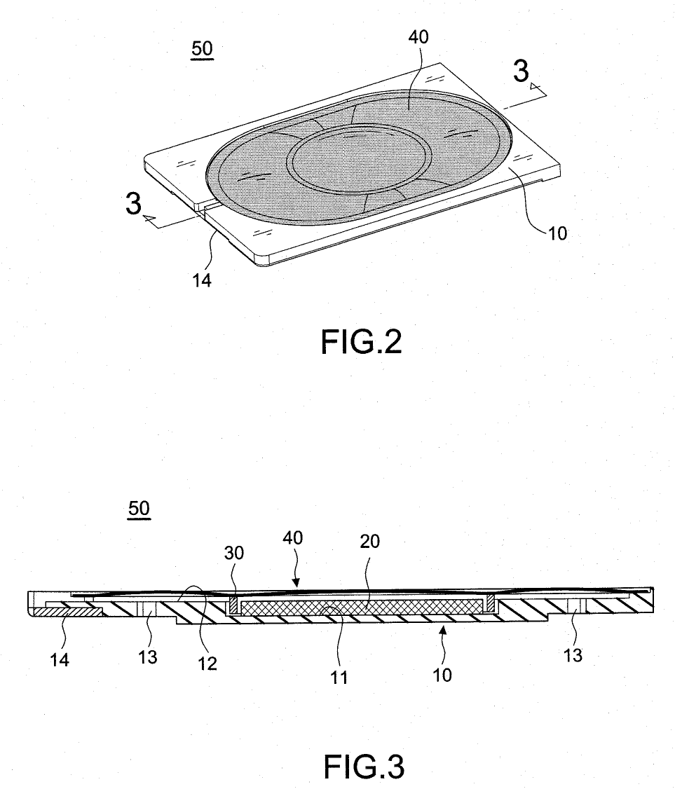

First of all, referring to FIGS. 1 through 5, a first embodiment of a loudspeaker in accordance with the invention includes an iron basin 10, a magnet unit 20, a voice coil 30, and a vibrating diaphragm 40.

The iron basin 10 is constructed as a base made of heat-dissipating and magnetic conductive material. The iron basin 10 includes a first receiving portion 11 at the top surface thereof. According to the embodiment of the invention, the first receiving portion 11 is constructed as a circular recess, but should not be limited thereto. The first receiving portion 11 is provided for receiving the magnet unit 20 and the voice coil 30. According to the embodiment, the magnet unit 20 is a single magnet, but should not be limited thereto. The voice coil 30 is mounted at the external rim of the magnet unit 20.

The above-mentioned iron basin 10 fulfills the functions of the conventional support and yoke. Moreover, the entire iron basin 10 is a heat-dissipating and magnetic conductive body, thereby increasing the heat-dissipating surface and enhancing the magnetic conductive effect. In this way, the magnetic force may be considerably concentrated for improving the tone quality. Meanwhile, the improvement of the heat-dissipating efficiency may extend the service life and enhance the reliability of the loudspeaker.

Moreover, the iron basin 10 includes further a second receiving portion 12 at the top surface thereof. According to the embodiment, the second receiving portion 12 is disposed around the first receiving portion 11 for receiving a vibrating diaphragm 40. According to the embodiment, the vibrating diaphragm 40 is oval-shaped, but should not be limited thereto. Besides, at least one air orifice 13 is formed in the second receiving portion 12. In addition, the iron basin 10 includes a terminal board 14 at the external end thereof for connecting to the external sound source signal.

The iron basin 10, the magnet unit 20, the voice coil 30, and the vibrating diaphragm 40 are assembled to form a mini-speaker 50.

The loudspeaker in accordance with the invention is characterized in that the iron basin 10 serves as both the support and the yoke. This structural design not only increases the entire mechanical strength, but also maintains the overall thickness within a predetermined range (e.g. <1.5 mm, even ca. 1.0 mm). In this way, the loudspeaker in accordance with the invention meets the thinness requirement. Moreover, both the heat-dissipating effect and the magnetic conductive effect are enhanced, thereby facilitating the internal space design of the electronic products. Furthermore, the lightweight and thinness requirements are also fulfilled.

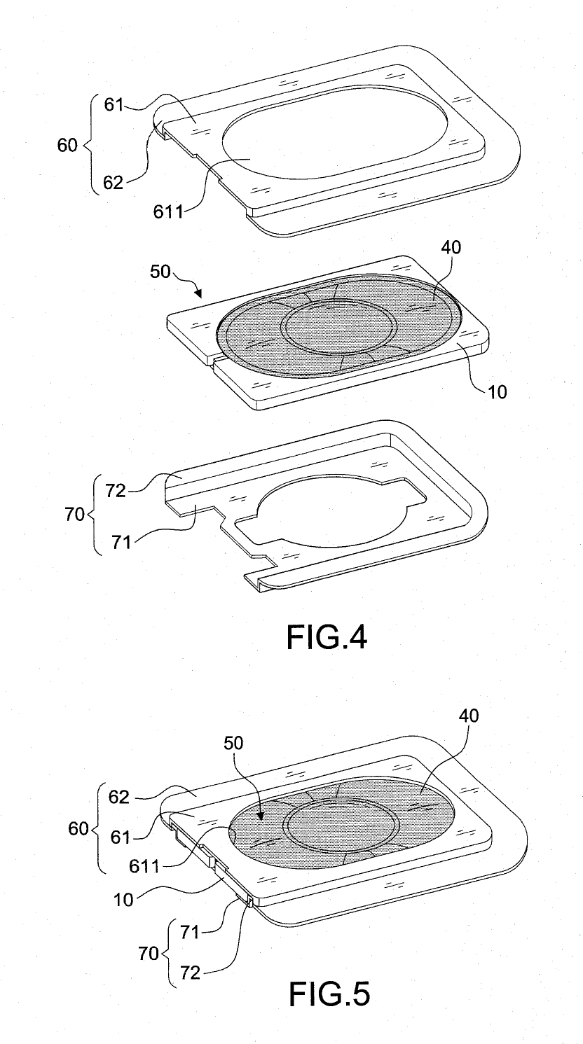

As shown in FIGS. 4 and 5, the mini-speaker 50 in accordance with the invention further includes a top metal cover 60 and a bottom metal cover 70 to enclose the mini-speaker 50. The top metal cover 60 is made of thin metal sheet by the stamping process and has a [symbol] -shaped cross-section, thereby forming a middle protrusion 61 and a peripheral flange portion 62 (but should not be limited thereto). Depending on different requirements and the type of the vibrating diaphragm 40, one single large sound hole or several small sound holes may be formed at the surface of the middle protrusion 61. One single large sound hole 611 is employed in the embodiment (but should not be limited thereto).

The bottom metal cover 70 is formed depending on the top metal cover 60 and therefore has a [symbol] -shaped cross-section, thereby forming a middle recess 71 and a peripheral contact portion 72. According to the preferred embodiment, the contact portion 72 is mounted on the middle protrusion 61 of the top metal cover 60 ((but should not be limited thereto). This structure permits a rapid attachment of the bottom metal cover 70 to the top metal cover 60. Moreover, the mini-speaker 50 may be fully protected by the enclosure structure. In addition, the bottom metal cover 70 is in contact with the iron basin 10, thereby increasing the heat-dissipating surface of the iron basin 10.

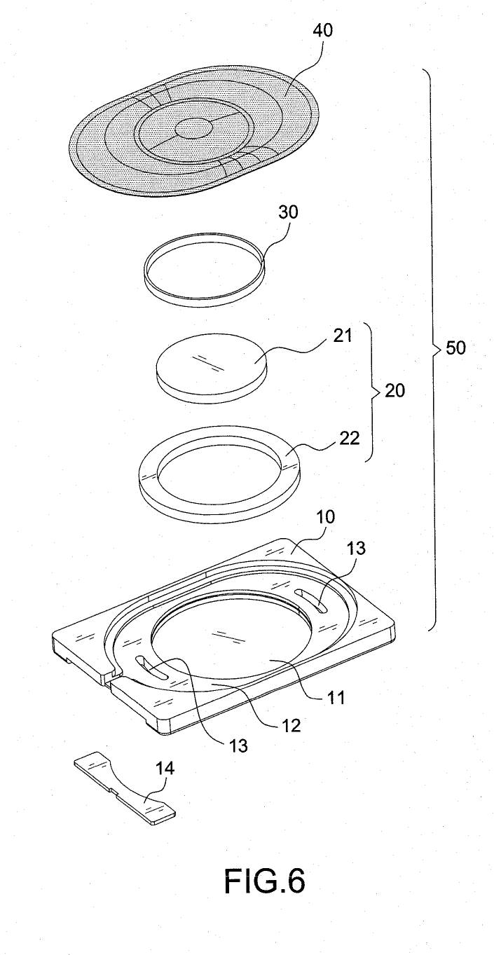

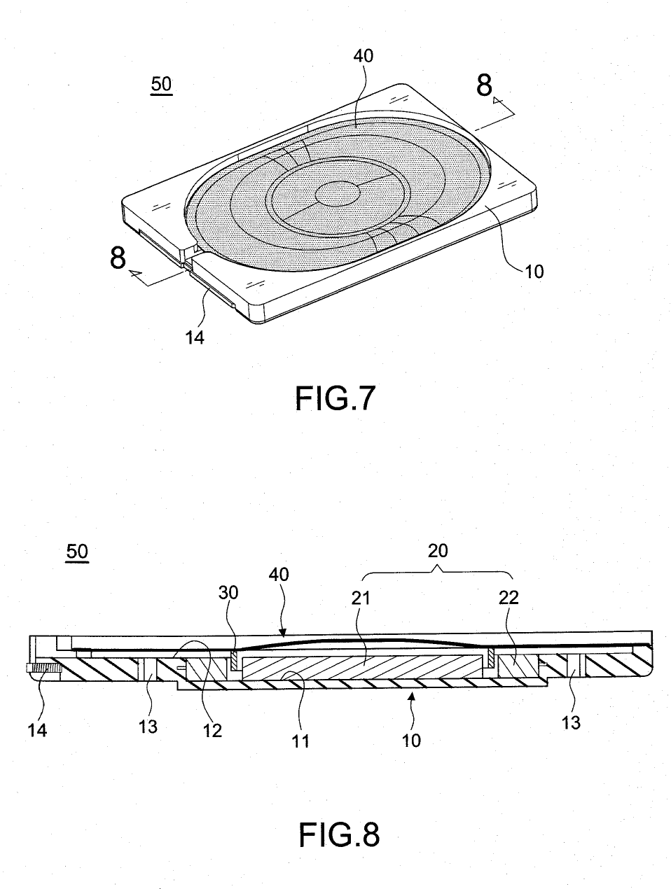

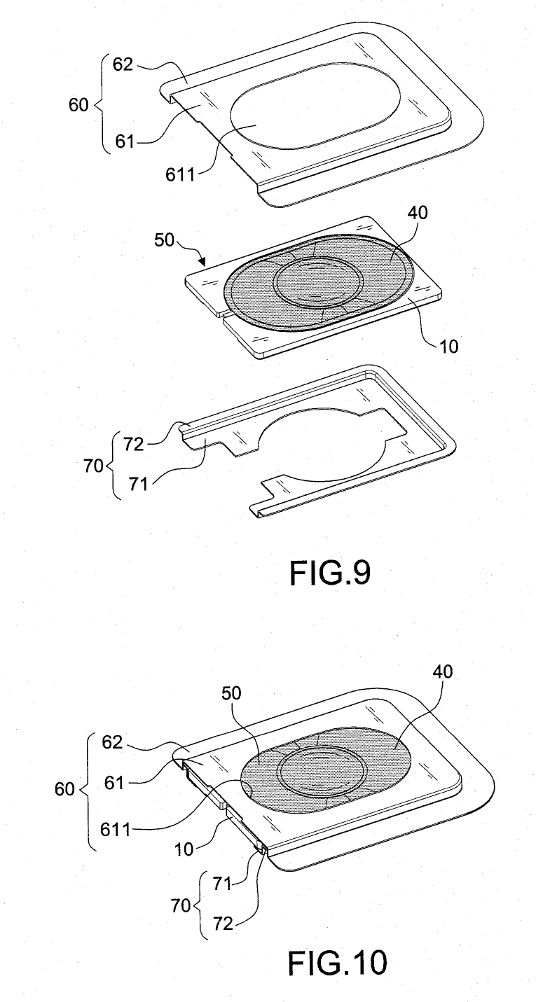

FIGS. 6 through 10 illustrate a second embodiment of the invention. The components identical to the first embodiment are marked with the same reference signs. The different between them lies in that the magnet unit 20 consists of an internal magnet 21 and an external magnet 22. The voice coil 30 is interposed between the internal and external magnets 21, 22. According to the second embodiment, the internal and external magnets 21, 22 and the voice coil 30 are received within the first receiving portion 11. Their functions are identical to the first embodiment so that no further descriptions are given hereinafter. The vibrating diaphragm 40, the top and bottom metal covers 60, 70 may be slightly changed in their form without affecting their functions. The second embodiment is substantially the same to the first embodiment in technical features and means except that the structure is slightly changed. As a result, the second embodiment also achieves the same effects of the first embodiment.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An ultra-thin loudspeaker, comprising:
a) an iron basin having a first receiving portion and a second receiving portion at the top surface thereof;
b) a magnet unit positioned within the first receiving portion of the iron basin;
c) a voice coil positioned around the magnet unit; and
d) a vibrating diaphragm positioned within the second receiving portion, whereby the iron basin, the magnet unit, the voice coil, and the vibrating diaphragm are assembled to form a mini-speaker.

2. The ultra-thin loudspeaker as recited in claim 1 wherein the magnet unit includes a single magnet, and the voice coil is positioned around the single magnet.

3. The ultra-thin loudspeaker as recited in claim 1 wherein the magnet unit includes an internal magnet and an external magnet, and wherein the voice coil is interposed between the internal and external magnet.

4. The ultra-thin loudspeaker as recited in claim 2 wherein at least one air orifice is formed in the second receiving portion.

5. The ultra-thin loudspeaker as recited in claim 3 wherein at least one air orifice is formed in the second receiving portion.

6. The ultra-thin loudspeaker as recited in claim 2 wherein the iron basin includes a terminal board at the external bottom end thereof.

7. The ultra-thin loudspeaker as recited in claim 3 wherein the iron basin includes a terminal board at the external bottom end thereof.

8. The ultra-thin loudspeaker as recited in claim 2 wherein the mini-speaker further includes a top metal cover and a bottom metal cover to enclose the mini-speaker.

9. The ultra-thin loudspeaker as recited in claim 3 wherein the mini-speaker further includes a top metal cover and a bottom metal cover to enclose the mini-speaker.

10. The ultra-thin loudspeaker as recited in claim 8 wherein the top metal cover has a [symbol] -shaped cross-section, thereby forming a middle protrusion and a peripheral flange portion, and wherein the bottom metal cover has a [symbol] -shaped cross-section, thereby forming a middle recess and a peripheral contact portion, and wherein the contact portion is mounted at the internal rim of the protrusion of the top metal cover, thereby enclosing the mini-speaker.

11. The ultra-thin loudspeaker as recited in claim 9 wherein the top metal cover has a [symbol] -shaped cross-section, thereby forming a middle protrusion and a peripheral flange portion, and wherein the bottom metal cover has a [symbol] -shaped cross-section, thereby forming a middle recess and a peripheral contact portion, and wherein the contact portion is mounted at the internal rim of the protrusion of the top metal cover, thereby enclosing the mini-speaker.
